(19) United States
(12) Patent Application Publication
(10) Pub. No.: US 2025/0209355 A1
(43) Pub. Date: Jun. 26, 2025

(54) Fast Speculative Decoding Using Multiple Parallel Drafts

(71) Applicant: Google LLC, Mountain View, CA (US)

(72) Inventors: Ziteng Sun, Jersey City, NJ (US); Ananda Theertha Suresh, Jersey City, NJ (US); Jae Hun Ro, New York, NY (US); Ahmad Beirami, New York, NY (US); Himanshu Jain, New York, NY (US); Xinnan Yu, New York, NY (US); Michael Dennis Riley, New York, NY (US); Sanjiv Kumar, Jericho, NY (US)

(21) Appl. No.: 18/990,227

(22) Filed: Dec. 20, 2024

Related U.S. Application Data
(60) Provisional application No. 63/613,424, filed on Dec. 21, 2023.

(51) Int. Cl. G06N 7/01

(52) U.S. Cl. CPC G06N 7/01

(57) ABSTRACT

Systems and methods are provided for low-latency autoregressive generation of sequence output based on a plurality of parallel draft sequences. A lower-latency machine-learned model (e.g., having a smaller number of parameters than a model of interest) can generate a plurality of draft sequences comprising a plurality of draft tokens per sequence. A machine-learned model of interest (e.g., having a high latency per token) can evaluate a plurality of respective conditional probabilities for the respective draft tokens in parallel. An output sequence comprising one or more accepted draft tokens, corrected tokens, and/or additional tokens can be generated based on the draft tokens and conditional probabilities.

### CROSS-REFERENCE TO RELATED APPLICATIONS

The present application is based upon and claims the right of priority to U.S. Provisional Patent Application No. 63/613,424, filed on Dec. 21, 2023, the disclosure of which (including any appendices) is hereby incorporated by reference herein in its entirety for all purposes.

### FIELD

The present disclosure relates generally to machine learning processes and machine-learned devices and systems. More particularly, the present disclosure relates to low-latency decoding for machine-learned sequence processing tasks (e.g., language generation).

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by a computing system comprising one or more computing devices, an input context. The example method can include generating, by the computing system using one or more first machine-learned sequence processing models and based on the input context, a plurality of draft sequences, wherein each draft sequence of the plurality of draft sequences is configured to immediately follow the input context. The example method can include evaluating, using a second, different machine-learned sequence processing model and based on the input context by the computing system, a respective conditional probability for each of one or more tokens of each of the plurality of draft sequences. The example method can include selecting, by the computing system, one or more of the tokens from one of the plurality of draft sequences for inclusion in an output sequence based on the respective conditional probabilities. The example method can include providing, by the computing system, the output sequence as output.

In the example method, a first draft sequence of the plurality of draft sequences can include a first draft token associated with a first respective conditional probability. In the example method, a second draft sequence of the plurality of draft sequences can include a second draft token associated with a second respective conditional probability. In the example method, evaluating can include evaluating the first respective conditional probability and second respective conditional probability in parallel.

In the example method, the respective conditional probability can be a respective second-model conditional probability. In the example method, generating a draft sequence can include evaluating, using the one or more first machine-learned sequence processing models and based on the input context by the computing system, a respective first-model conditional probability for each of the one or more tokens of each of the plurality of draft sequences. In the example method, selecting one or more tokens for inclusion in an output sequence can include determining, based on a comparison between at least one respective first-model conditional probability and at least one respective second-model conditional probability, whether to include a draft token associated with the at least one respective first-model conditional probability and the at least one respective second-model conditional probability.

In the example method, determining whether to include the draft token can include: generating a random value; determining, based at least in part on the respective first-model conditional probability and the respective second-model conditional probability, a sampling threshold; and determining, based on a comparison between the random value and the sampling threshold, whether to include the draft token in the output sequence.

In the example method, a ratio ρ of a quotient q(x)/p(x) to the sampling threshold can be between 1 and k inclusive, wherein q(x) can be the respective second-model conditional probability, p(x) can be the respective first-model conditional probability, and k can be a number of draft sequences of the plurality of draft sequences.

In the example method, the ratio ρ of the quotient to the sampling threshold can be greater than or equal to ρ*, where

$${ρ}^{*} = \frac{1 - {( 1 - {\sum }_{x ∈ Ω} min ( p ( x ) , \frac{q ( x )}{{ρ}^{*}} ) )}^{k}}{{\sum }_{x ∈ Ω} min ( p ( x ) , \frac{q ( x )}{{ρ}^{*}} )} .$$

In the example method, a probability distribution of the output sequence can be equivalent to a probability distribution of the second machine-learned sequence processing model.

In the example method, selecting one or more tokens for inclusion can include obtaining a valid transport plan between a probability distribution of the one or more first machine-learned sequence processing models and a probability distribution of the second machine-learned sequence processing model; and determining, based on the valid transport plan, whether to accept a draft token of the plurality of draft sequences.

In the example method, obtaining the valid transport plan can include linear programming.

In the example method, the draft token associated with the at least one respective first-model conditional probability and the at least one respective second-model conditional probability can be not included in the output sequence. The example method can include determining, by the computing system and using a conditional probability distribution of the one or more first machine-learned sequence processing models and a conditional probability distribution of the second machine-learned sequence processing model, a residual probability distribution. The example method can include determining, based on the residual probability distribution, an output token to include in the output sequence.

In the example method, determining the output token can include random sampling based on the residual probability distribution.

In the example method, the draft token associated with the at least one respective first-model conditional probability and the at least one respective second-model conditional probability can be included in the output sequence. The example method can include determining, using the second machine-learned sequence processing model and based at least in part on the input context and the draft token associated with the at least one respective first-model conditional probability and the at least one respective second-model conditional probability, a conditional probability distribution of the second machine-learned sequence processing model. The example method can include randomly sampling an additional output token based on the conditional probability distribution. The example method can comprise including the additional output token in the output sequence.

Example aspects of the present disclosure provide one or more example non-transitory computer-readable media storing instructions that are executable by one or more processors to cause a computing system to perform example operations. In some implementations, the example operations can include obtaining an input context. The example operations can include generating, using one or more first machine-learned sequence processing models and based on the input context, a plurality of draft sequences, wherein each draft sequence of the plurality of draft sequences is configured to immediately follow the input context. The example operations can include evaluating, using a second, different machine-learned sequence processing model and based on the input context, a respective conditional probability for each of one or more tokens of each of the plurality of draft sequences. The example operations can include selecting one or more of the tokens from one of the plurality of draft sequences for inclusion in an output sequence based on the respective conditional probabilities. The example operations can include providing the output sequence as output.

Example aspects of the present disclosure provide an example computing system that includes one or more processors and one or more example non-transitory computer-readable media storing instructions that are executable by one or more processors to cause a computing system to perform example operations. In some implementations, the example operations can include obtaining an input context. The example operations can include generating, using one or more first machine-learned sequence processing models and based on the input context, a plurality of draft sequences, wherein each draft sequence of the plurality of draft sequences is configured to immediately follow the input context. The example operations can include evaluating, using a second, different machine-learned sequence processing model and based on the input context, a respective conditional probability for each of one or more tokens of each of the plurality of draft sequences. The example operations can include selecting one or more of the tokens from one of the plurality of draft sequences for inclusion in an output sequence based on the respective conditional probabilities. The example operations can include providing the output sequence as output.

In the example operations, a first draft sequence of the plurality of draft sequences can include a first draft token associated with a first respective conditional probability. In the example operations, a second draft sequence of the plurality of draft sequences can include a second draft token associated with a second respective conditional probability. In the example operations, evaluating can include evaluating the first respective conditional probability and second respective conditional probability in parallel.

In the example operations, the respective conditional probability can be a respective second-model conditional probability. In the example operations, generating a draft sequence can include evaluating, using the one or more first machine-learned sequence processing models and based on the input context by the computing system, a respective first-model conditional probability for each of the one or more tokens of each of the plurality of draft sequences. In the example operations, selecting one or more tokens for inclusion in an output sequence can include determining, based on a comparison between at least one respective first-model conditional probability and at least one respective second-model conditional probability, whether to include a draft token associated with the at least one respective first-model conditional probability and the at least one respective second-model conditional probability.

In the example operations, determining whether to include the draft token can include: generating a random value; determining, based at least in part on the respective first-model conditional probability and the respective second-model conditional probability, a sampling threshold; and determining, based on a comparison between the random value and the sampling threshold, whether to include the draft token in the output sequence.

In the example operations, a probability distribution of the output sequence can be equivalent to a probability distribution of the second machine-learned sequence processing model.

In the example operations, the draft token associated with the at least one respective first-model conditional probability and the at least one respective second-model conditional probability can be not included in the output sequence. The example operations can include determining, by the computing system and using a conditional probability distribution of the one or more first machine-learned sequence processing models and a conditional probability distribution of the second machine-learned sequence processing model, a residual probability distribution. The example operations can include determining, based on the residual probability distribution, an output token to include in the output sequence.

In the example operations, the draft token associated with the at least one respective first-model conditional probability and the at least one respective second-model conditional probability can be included in the output sequence. The example operations can include determining, using the second machine-learned sequence processing model and based at least in part on the input context and the draft token associated with the at least one respective first-model conditional probability and the at least one respective second-model conditional probability, a conditional probability distribution of the second machine-learned sequence processing model. The example operations can include randomly sampling an additional output token based on the conditional probability distribution. The example operations can comprise including the additional output token in the output sequence.

Other example aspects of the present disclosure are directed to other systems, methods, apparatuses, tangible non-transitory computer-readable media, and devices for performing functions described herein. These and other features, aspects, and advantages of various implementations will become better understood with reference to the following description and appended claims. The accompanying drawings, which are incorporated in and constitute a part of this specification, illustrate implementations of the present disclosure and, together with the description, help explain the related principles.

### BRIEF DESCRIPTION OF THE DRAWINGS

FIG. 1 is a block diagram of an example system according to example embodiments of the present disclosure.

FIG. 2 is a block diagram of an example system according to example embodiments of the present disclosure.

FIG. 3 is an illustration of an example plurality of draft sequences and associated example output sequence according to example embodiments of the present disclosure.

FIG. 4 is a flow chart diagram of an example method according to example aspects of the present disclosure.

FIG. 5 is a flow chart diagram of an example method according to example aspects of the present disclosure.

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

### Overview

Generally, the present disclosure is directed to systems and methods for low-latency decoding for machine-learned sequence processing tasks (e.g., language generation). More particularly, the present disclosure is directed to generating an output associated with a higher-latency machine-learned sequence processing model (e.g., large language model) based on one or more draft outputs associated with one or more lower-latency machine-learned sequence processing models (e.g., smaller language models).

For example, a higher-latency sequence processing model can be configured to autoregressively generate a sequence of output tokens, wherein each output token after a first output token can depend on one or more (e.g., all) output tokens that came before it. In some instances, generating an output token can include generating a probability distribution based on an input context and one or more (e.g., all) prior output tokens and randomly sampling an output token from the probability distribution. In such instances, the higher-latency model may not be configured to begin computing a next-token probability distribution until after all prior output tokens have been generated. In such instances, a latency associated with an entire output sequence (e.g. comprising dozens of tokens, etc.) can be high due to the time required to sequentially generate a large number of tokens.

In some instances, a lower-latency sequence processing model can be configured to generate one or more draft outputs for use by the higher-latency model. For example, in some instances, a lower-latency model can have a number of parameters that is much smaller than a number of parameters of the higher-latency model. In some instances, a very-low-latency (e.g., very small) model can generate multiple draft output tokens (e.g., one draft output sequence, multiple draft output sequences, etc.) in an amount of time that is small compared to an amount of time required to generate output tokens using the higher-latency model.

In some instances, the higher-latency model can evaluate a plurality of draft tokens in parallel. For example, in some instances, the lower-latency model can generate k sequences of n tokens per sequence for a total of k*n draft output tokens, wherein k and n can be integers. The higher-latency model can then generate a plurality of probability distributions in parallel, with each probability distribution based on the input context and zero or more draft output tokens (e.g., the first two draft tokens of the third sequence; all n tokens of the kth sequence, etc.). In this manner, for instance, a large number (e.g., k*n+1) of probability distributions can be generated, and a large number of draft tokens can be evaluated, in an amount of time that is not much larger than an amount of time required to generate one token using the higher-latency model alone.

In some instances, a computing system can accept or reject one or more draft output tokens based on a probability distribution of the lower-latency model and a probability distribution of the higher-latency model. In some instances, if one or more tokens are rejected, the computing system can generate a corrected token based on the probability distributions used in determining the rejection. In some instances, if an entire draft sequence is accepted, the computing system can sample an additional output token to follow the last draft token of the draft sequence. This additional output token can be sampled from a probability distribution based on the input context and all n tokens of the accepted draft output sequence, which can be computed in parallel with the probability distributions used to determine rejection and acceptance.

In some instances, the computing system's method for determining rejection or acceptance, and the computing system's method for generating corrected tokens, can be configured so that a probability distribution of the final output sequence is equal to a probability distribution of the higher-latency model. In some instances, this can be achieved by generating a mapping between a probability distribution of the lower-latency model and a probability distribution of the higher-latency model. For example, a mapping between the probability distributions can be generated such that each draft output token is mapped (e.g., probabilistically mapped) to a corresponding output token of the higher-latency model based, at least in part, on a ratio of a first probability to a second probability. A mapping can also be referred to as a “transport plan.” The first probability can be a probability of the draft output token associated with the probability distribution of the lower-latency model, and the second probability can be a probability of the draft output token associated with the probability distribution of the higher-latency model. When the draft output token is mapped to itself (i.e., to a corresponding output token that is the same as the draft output token), then the draft output token can be accepted. When the draft output token is not mapped to itself, it can be rejected and replaced with a corrected token, which can be the corresponding output token it was mapped to.

Example aspects of the present disclosure provide systems and methods for generating mappings between probability distributions for use in determining accepted, rejected, and corrected tokens based on a plurality of parallel draft sequences. In one example aspect, a theoretically optimal mapping is provided that can maximize an acceptance probability associated with one or more draft output tokens. In another example aspect, a near-optimal mapping (i.e., having a near-optimal bounded acceptance probability) is provided that can in some instances (e.g., when a number of draft sequences is large) be determined more quickly than the provided optimal mapping.

Systems and methods of the present disclosure have a variety of technical effects and benefits. For example, systems and methods of the present disclosure can in some instances generate an output sequence associated with a higher-latency sequence processing model in less time (e.g., wall clock time) than prior methods of generating an output sequence associated with the same higher-latency sequence processing model (e.g., more than twice as fast as standard autoregressive decoding, 37 percent faster than prior speculative decoding methods, etc.). Thus, systems and methods of the present disclosure can improve the functioning of a computing system by enabling the performance of a similar (e.g., same) task in less time than prior methods.

Additionally, it will be appreciated that more efficient (e.g., faster) systems and methods can in some instances enable performance of a similar (e.g., same) task in a similar (e.g., same) amount of time using lower-performance (e.g., slower) hardware than prior methods. Thus, it will be appreciated that in some instances involving a given latency target, systems and methods of the present disclosure can enable output sequence generation using a lower-performance processor than prior systems and methods. Additionally, it will be appreciated that a lower-performance processor (e.g., lower number of sequential FLOPS per second, etc.) can in some instances be associated with a lower cost (e.g., manufacturing cost, energy cost of operation, etc.) than a higher-performance processor. Thus, it will be appreciated that systems and methods of the present disclosure can in some instances reduce a cost (e.g., an energy cost) associated with a given task (e.g., generating an output sequence within a given latency target).

Thus, it will be appreciated that a technical effect of example implementations of the present disclosure is increased energy efficiency in performing operations using machine-learned models, thereby improving the functioning of computers implementing such models. In some scenarios, increased energy efficiency can provide for less energy to be used to perform a given task (e.g., less energy expended to maintain the model in memory, less energy expended to perform calculations within the model, etc.). In some scenarios, increased energy efficiency can provide for more task(s) to be completed for a given energy budget (e.g., a larger quantity of tasks, more complex tasks, the same task but with more accuracy or precision, etc.).

In this manner, for instance, the improved energy efficiency of example implementations of the present disclosure can reduce an amount of pollution or other waste associated with implementing machine-learned models and systems, thereby advancing the field of machine-learning and artificial intelligence as a whole. The amount of pollution can be reduced in toto (e.g., an absolute magnitude thereof) or on a normalized basis (e.g., energy per task, per model size, etc.). For example, an amount of CO2 released (e.g., by a power source) in association with training and execution of machine-learned models can be reduced by implementing more energy-efficient training or inference operations. An amount of heat pollution in an environment (e.g., by the processors/storage locations) can be reduced by implementing more energy-efficient training or inference operations.

Various example implementations are described herein with respect to the accompanying Figures.

### Example Systems and Architectures

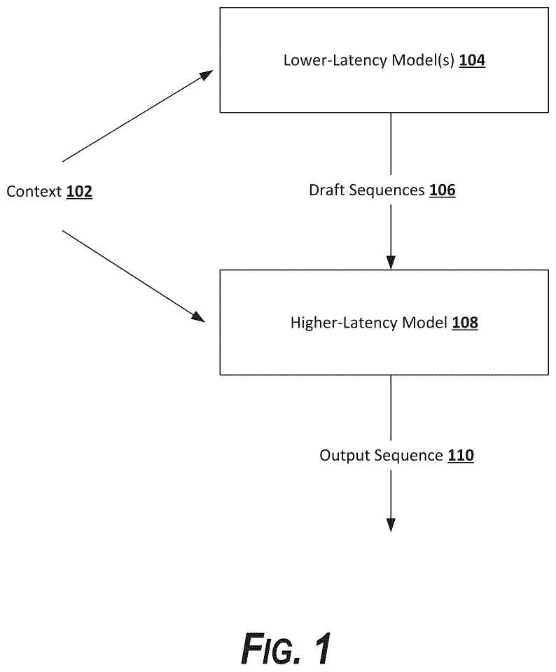

FIG. 1 is a block diagram of an example system according to example embodiments of the present disclosure, in which an output sequence 110 is generated based on an input context 102. A lower-latency machine-learned model 104 can generate a plurality of draft sequences 106 based on the context 102. A large machine-learned model 108 can generate an output sequence 110 based on the context 102 and the draft sequences 106.

FIG. 1 depicts a context 102. The context 102 can generally include or otherwise represent various types of data. In some instances, the context 102 can include sequence data (e.g., text sequence, audio sequence, image sequence, etc.). The context 102 can be obtained in any appropriate manner (e.g. received from a user or computing system, retrieved from one or more non-transitory computer-readable media, generated, etc.)

FIG. 1 depicts one or more lower-latency model(s) 104. The lower-latency model 104 can include one or more machine-learned models. The lower-latency model(s) 104 can include various model architectures. An example model architecture for lower-latency model(s) 104 can include a sequence processing model architecture (e.g., a transformer model). For example, the lower-latency model(s) 104 can be configured to receive an input sequence and generate an output sequence. For instance, the lower-latency model(s) 104 can be configured to generate an output sequence where elements of the output sequence are predicted based on the elements of the input sequence.

FIG. 1 depicts one or more draft sequences 106. The draft sequences 106 can generally include or otherwise represent various types of sequence data (e.g., text sequence, audio sequence, image sequence, etc.). In some instances, the sequence data can comprise one or more tokens.

FIG. 1 depicts the lower-latency model(s) 104 generating the draft sequences 106. In some instances, generating the draft sequences 106 can comprise generating one or more conditional probability distributions based at least in part on the context 102. In some instances, generating the draft sequences 106 can comprise sampling from a respective conditional probability distribution to determine a respective draft token. In some instances, a conditional probability distribution used to generate a later token (e.g. second token sequentially, third token sequentially, etc.) of a draft sequence 106 can be based on the context 102 and one or more (e.g., all) earlier tokens (e.g., first token sequentially, etc.) of the same draft sequence 106. In some instances, the conditional probability distribution can include a plurality of respective conditional probabilities associated with a plurality of possible tokens. In some instances, each output token of each draft sequence 106 can be associated with a respective conditional probability of a conditional probability distribution from which it was sampled.

FIG. 1 depicts a higher-latency model 108. The higher-latency model 108 can include one or more machine-learned models. The higher-latency model 108 can include various model architectures. An example model architecture for higher-latency model 108 can include a sequence processing model architecture (e.g., a transformer model). For example, the higher-latency model 108 can be configured to receive an input sequence and generate an output sequence. For instance, the higher-latency model 108 can be configured to generate an output sequence where elements of the output sequence are predicted based on the elements of the input sequence.

The higher-latency model 108 can have one or more properties (e.g. model type, architecture, etc.) that are the same as or different from a corresponding property of the lower-latency model 104. In some instances, the higher-latency model 108 can be characterized by a latency that is larger than a corresponding latency of the lower-latency model 104 (e.g., due to a higher number of parameters, different model architectures, etc.). In some instances, the higher-latency model 108 can be characterized by a size (e.g. a number of parameters, etc.) that is larger than a size of the lower-latency model 104.

FIG. 1 depicts an output sequence 110. The output sequence 110 can generally include or otherwise represent various types of sequence data (e.g., text sequence, audio sequence, image sequence, etc.). In some instances, the sequence data can comprise one or more tokens. In some instances, the output sequence 110 can comprise one or more tokens of one or more draft sequences 106. In some instances, the output sequence 110 can comprise one or more tokens that are not included in any draft sequences 106.

FIG. 1 depicts the higher-latency model 108 generating an output sequence 110 based on the draft sequences 106. In some instances, generating an output sequence 110 can comprise generating one or more conditional probability distributions of the higher-latency model based at least in part on the context 102. In some instances, a conditional probability distribution associated with a later token (e.g. second token sequentially, third token sequentially, etc.) of a draft sequence 106 can be based on the context 102 and one or more (e.g., all) earlier tokens (e.g., first token sequentially, etc.) of the same draft sequence 106.

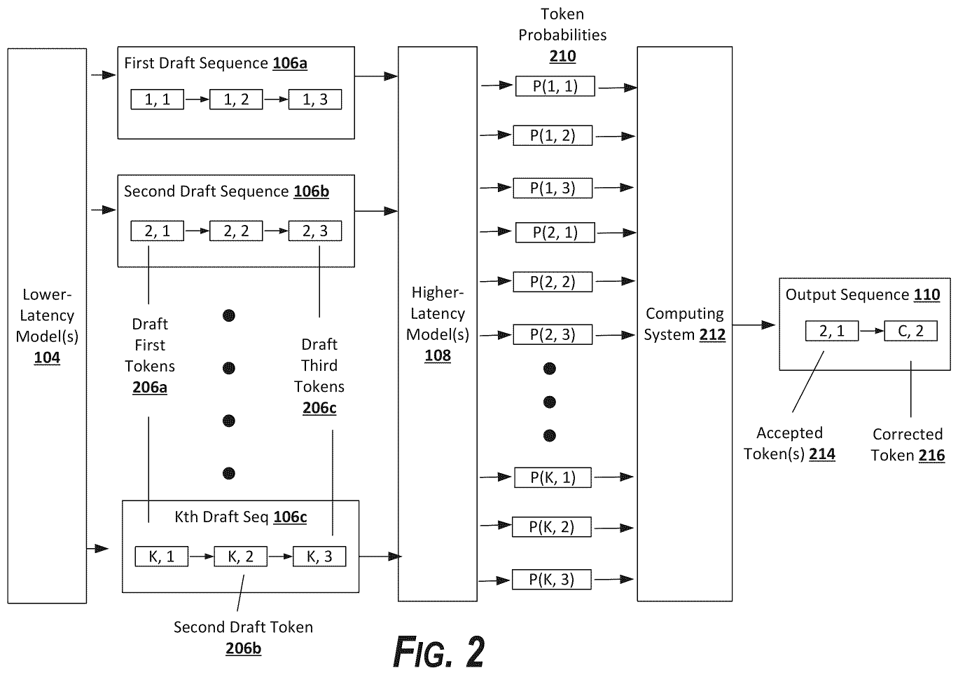

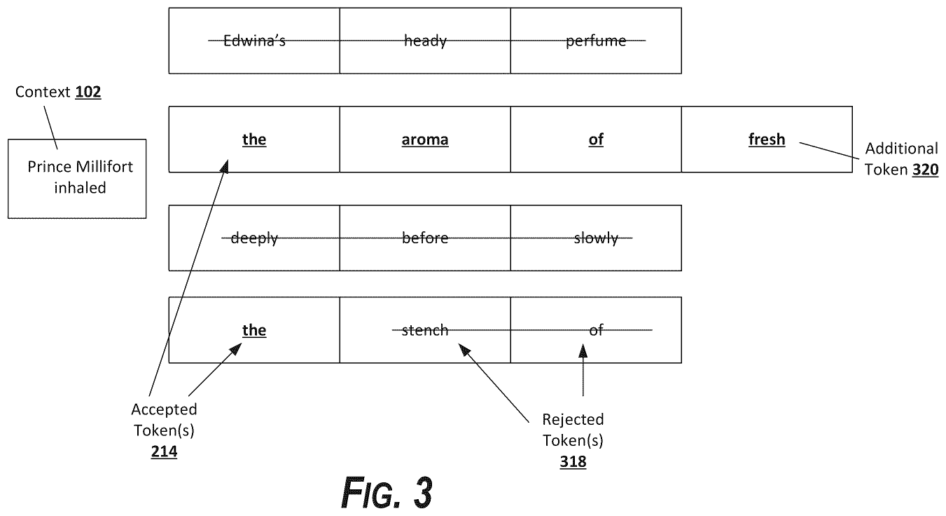

In some instances, generating an output sequence 110 can include accepting or rejecting a draft token of a draft sequence 106. In some instances, accepting or rejecting can be based at least in part on a conditional probability distribution of the higher-latency model and a corresponding conditional probability distribution of the lower-latency model. In some instances, accepting or rejecting a draft token can be based on a conditional probability of the lower-latency model associated with the draft token, and on a conditional probability of the higher-latency model associated with the draft token. In some instances, accepting or rejecting a draft token can be based on a mapping (e.g., an optimal transport plan) between a conditional probability distribution of the lower-latency model and a conditional probability distribution of the higher-latency model. Example implementations for generating an output sequence 110 based on one or more conditional probabilities are further described below with respect to FIGS. 2 and 3.

FIG. 2 is a block diagram of an example system according to example embodiments of the present disclosure. A lower-latency model 104 can generate k draft sequences 106a, 106b, 106c, wherein each draft sequence can comprise a draft first token 206a, draft second token 206b, draft third token 206c, etc. A higher-latency model 108 can generate a respective token probability 210 for each draft token 206 of each draft sequence 106a, 106b, 106c. Based on the token probabilities 210, a computing system 212 can determine an output sequence 110, which can in some instances comprise one or more accepted token(s) 214 or one or more corrected tokens 216.

FIG. 2 depicts first, second, and kth draft sequences 106a, 106b, and 106c. These draft sequences can be or comprise draft sequences 106 as described with respect to FIG. 1. The first draft sequence 106a can include one or more tokens that are the same as or different from one or more tokens of the draft sequences 106b, 106c. Similarly, the second draft sequence 106b or any other draft sequence 106 can include one or more tokens that are the same as or different from the kth draft sequence 106c or any other draft sequence 106. For example, in some instances, a first draft sequence 106a may include a first token that is identical to a first token of the second draft sequence 106b, and may include a second token that is different from a second token of the second draft sequence 106b. Other combinations are possible. In some instances, coincidental duplication of entire draft sequences 106a,b,c may be possible (but in some instances unlikely). In other instances, draft sequences 106a, b, and c may be generated in a manner that prevents such duplication (e.g., via sampling without replacement).

Although the first, second, and kth draft sequences 106a, b, c are labeled using ordinal numbers (e.g., “first”), it will be appreciated that this labeling is for convenience only and does not imply that the draft sequences 106a, b, and c are necessarily arranged or generated in any particular order or are sequential relative to each other. For example, in some instances the draft sequences 106a, b, and c can be parallel sequences, such that a first token of each draft sequence 106a, b, and c is configured to immediately follow a context 102. When referring to sequentially ordered information, the present disclosure will in some instances use phrases such as “first sequentially” to indicate a relative position within a sequence.

FIG. 2 depicts a plurality of draft first tokens 206a. Draft first tokens 206a can comprise, for example, various types of data configured to form part of a sequence (e.g., text data, image data, audio data, semantic data, etc.). In some instances, draft first token 206a can be a token that is the first token sequentially in a draft sequence 106a, b, c. A draft first token 206a can, for example, be configured to immediately follow a context 102 in a sequence (e.g., text sequence, image sequence, audio sequence, etc.). In some instances, the draft first token 206a can be generated, for example, based solely on a context 102 (e.g., without being based on, for example, any other token of the same draft sequence 106). In some instances, a plurality of first draft tokens 206a can be independent and identically distributed (i.i.d.) samples from a same base distribution (e.g., a conditional probability distribution of a single lower-latency model 104). In other instances, a plurality of first draft tokens 206a may be sampled from different distributions (e.g., associated with different lower-latency models 104), or may be sampled non-independently (e.g., sampling without replacement).

FIG. 2 depicts a plurality of draft second tokens 206b and third tokens 206c. Draft second and third tokens 206b,c can comprise, for example, various types of data configured to form part of a sequence (e.g., text data, image data, audio data, semantic data, etc.). In some instances, a draft second token 206b can be configured to immediately follow a draft first token 206a, and a draft third token 206c can be configured to immediately follow a draft second token of the same draft sequence 106. In some instances, a draft third token 206c of a particular draft sequence 106 can be generated based on an input context 102, a draft first token 206a of the same draft sequence 106, and a draft second token 206b of the same draft sequence 106. In some instances, a plurality of third draft tokens 206c or a plurality of second draft tokens 206b can be independent and identically distributed (i.i.d.) samples from a same base distribution (e.g., a conditional probability distribution of a single lower-latency model 104, based on identical first draft tokens 206a, etc.). In other instances, a plurality of third draft tokens 206c or a plurality of second draft tokens 206b may be sampled from different distributions (e.g., associated with different lower-latency models 104, based on different first draft tokens 206a, etc.), or may be sampled non-independently (e.g., sampling without replacement).

Although FIG. 2 depicts k draft sequences having one first draft token 206a each, one second draft token 206b each, and so on, it will be appreciated that other configurations are possible. For example, in some instances a prefix tree can be formed having k₁ first draft tokens 206a, wherein each first draft token 206a can be associated with k₂ second draft tokens 206b (e.g., a total of k₁*k₂ second draft tokens 206b), each second draft token can be associated with k₃ third draft tokens 206c, and so on. The numbers k₁, k₂, k₃, . . . , kₙ can be integers that are the same as or different from each other.

FIG. 2 depicts a plurality of token probabilities 210. The token probabilities 210 can be conditional probabilities of the higher-latency machine-learned model 108 associated with a draft token 206. For example, in some instances, the token probabilities 210 can be a probability of the higher-latency model 108 outputting an associated draft token 206 given a same context 102 and, where applicable, a same partial draft sequence 106a, b, c. As an illustrative example, a token probability 210 associated with a draft third token 206c of the kth draft sequence 106c can be a probability of the higher-latency model 108 outputting the draft third token 206c given a context 102 and the sequentially first two draft tokens 206a, b of the kth draft sequence 106c.

FIG. 2 depicts the higher-latency model 108 generating the token probabilities 210. Generating the token probabilities 210 can comprise, for example, generating a conditional probability distribution associated with a vocabulary (e.g., token vocabulary, word vocabulary, image vocabulary, sound vocabulary, etc.) of the higher-latency model 108, wherein a probability of the conditional probability distribution can be a token probability 210. In such instances, a token probability 210 associated with a draft token 206 can be a probability associated with a vocabulary member associated with the draft token 206. In some instances, a conditional probability distribution can be generated based on a context 102 and zero or more prior tokens of a same draft sequence 106a, b, c. In some instances, generating a conditional probability distribution of the higher-latency model 108 can comprise, for example, one or more steps associated with temperature sampling, top-k sampling, nucleus sampling, or other probabilistic sampling method. For example, generating a conditional probability distribution of the higher latency model can in some instances comprise generating a first numerical distribution (e.g., probability distribution, score distribution, etc.) associated with a vocabulary of the higher-latency model 108 and generating a scaled (e.g., temperature-scaled; normalized top-k; etc.) conditional probability distribution based on the first numerical distribution.

In some instances, a plurality of token probabilities 210 (e.g., token probabilities 210 associated with all n tokens of all k draft sequences 106, etc.) can be determined in parallel using parallel computation (e.g., a plurality of processors operating in parallel, etc.).

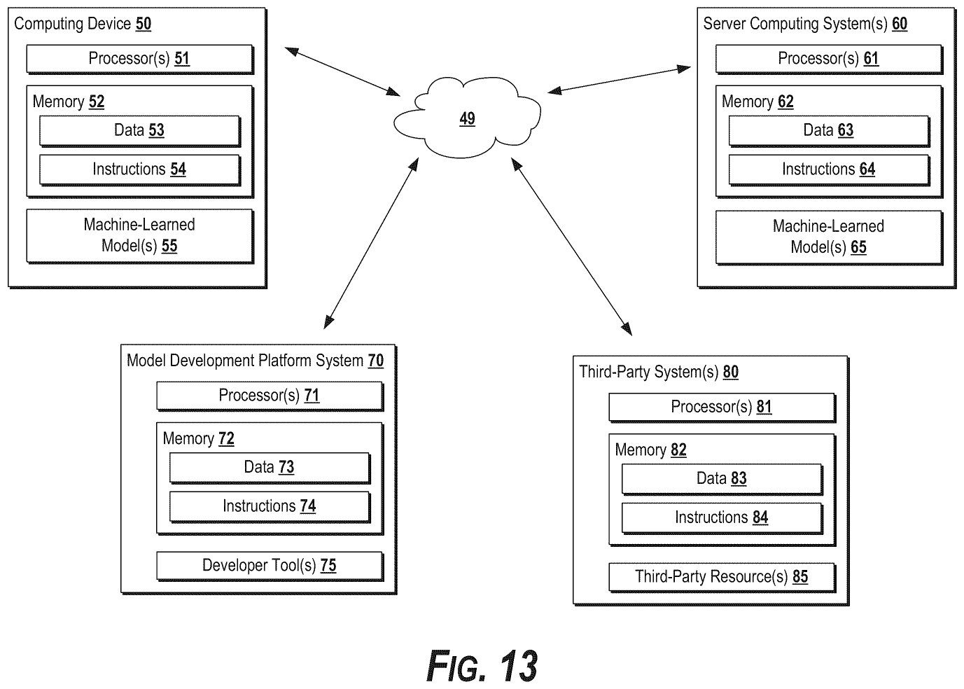

FIG. 2 depicts a computing system 212. The computing system 212 can comprise, for example, one or more computing devices. In some instances, a computing device can comprise one or more computing devices described with respect to FIGS. 13-15.

FIG. 2 depicts one or more accepted tokens 214. Accepted tokens 214 can comprise, for example, various types of data configured to form part of a sequence (e.g., text data, image data, audio data, semantic data, etc.). In some instances, an accepted token 214 can be, comprise, be the same as, or share one or more properties with a draft token 206. Accepted tokens 214 can in some instances be draft tokens 206 selected for inclusion in an output sequence 110.

FIG. 2 depicts the computing system 212 determining an accepted token 214 and a corrected token 216. Determining an accepted token 214 and corrected token 216 can comprise, for example, determining whether to accept or reject a draft token 206. This determination can be based, for instance, on one or more token probabilities 210 and one or more conditional probabilities of the lower-latency model(s) 104. Determining an accepted token 214 can comprise accepting a draft token 206 (e.g., including the draft token 206 in an output sequence 110). Determining a corrected token 216 can comprise for example, rejecting one or more draft tokens 206 (e.g., excluding the draft tokens 206 from an output sequence 110) and determining a corrected token 216 that is different from the rejected draft token 206. For example, if all k first draft tokens 206a are rejected, a corrected token 216 can be generated to immediately follow a context 102. As another example, if a first draft token 206a of the first draft sequence 106a is accepted, and a second draft token 206 of the first draft sequence 106a is rejected, a corrected token 216 can in some instances be generated to immediately follow the accepted token 214 associated with the first draft token 206a.

Determining whether to accept or reject a draft token 206 can comprise, for example, obtaining a mapping (e.g., coupling, transport plan) from one or more conditional probability distributions of the lower-latency model(s) 104 to a conditional probability distribution of the higher-latency model 108. In some instances, the mapping can be a probabilistic mapping, and determining whether to accept a draft token 206 can comprise, for example, generating a random value (e.g., between 0.0 and 1.0) and comparing the random value to a probability of the probabilistic mapping associated with the draft token 206. In some instances, the mapping can be configured to be a valid transport plan, such that a probability distribution associated with the output sequence 110 can be equal to a corresponding conditional probability distribution of the higher-latency model 108. In some instances, the mapping can be configured to optimize a cost associated with the transport plan. In some instances, the cost can be associated with an acceptance probability, rejection probability, or expected number of accepted/rejected tokens. For example, in some instances, a cost can be a membership cost, wherein a token of the output sequence 110 can be associated with a cost if it is not a member of a particular set of draft tokens 206 (e.g., all draft tokens 206a, etc.). For example, in some instances, a transport plan can be configured to optimize a membership cost wherein each corrected token 216 is associated with a cost of 1.0 and each accepted token 214 is associated with a cost of 0.0. In some instances, each unused token configured to appear sequentially later than the corrected token 216 can also be associated with a cost (e.g., 1.0). As an illustrative example, if a sequentially second token of an output sequence 110 is a corrected token 216, and each draft sequence is three tokens long, the unused third draft tokens 206c can be associated with a cost (e.g., 1.0). A person skilled in the art will appreciate that other cost amounts and cost configurations are possible.

In some instances, a mapping can comprise a coupling (e.g., a maximal coupling). A coupling can be defined as a joint probability distribution such that, for two probability distributions P over X and Q over Y, a joint distribution π supported over X×Y is a coupling between P and Q if:

$$∀ y ∈ Y , {\sum }_{x ∈ X} π ( x , y ) = Q ( y ) ,$$

$$and :$$

$$∀ x ∈ X , {\sum }_{y ∈ Y} π ( x , y ) = P ( x ) .$$

In some instances, an optimal transport plan can comprise a linear programming problem solving for the following minimum value, wherein P can be a product distribution associated with a product of k conditional probability distributions (e.g., a same probability distribution multiplied by itself k times, etc.) of a lower-latency model 104 conditioned on be a context 102 and zero or more draft tokens 206 appearing sequentially earlier in a sequence; Q can be a conditional probability distribution of the higher-latency model 108; Ω can be a vocabulary of the higher-latency model 108 (e.g., a vocabulary of all possible next tokens given the context 102 and zero or more draft tokens 206), of which y can be a member; and Ω^{k} can be k-dimensional vocabulary space representing all possible sets of k draft tokens 206 that can be generated based on a context 102 and zero or more draft tokens 206 (e.g., possible sets of k first draft tokens 206a associated with k draft sequences 106), of which x can be a member; π(x, y) can be associated with a probability that x is mapped to y; and Cost(x, y) can be a cost of mapping x to y:

$$min {\sum }_{x ∈ {Ω}^{k}} {\sum }_{y ∈ Ω} π ( x , y ) 1 \{ y ∉ S ( x ) \}$$

$$such that$$

$$∀ y ∈ Ω , {\sum }_{x} π ( x , y ) = Q ( y ) ,$$

$$∀ x ∈ {Ω}^{k} , {\sum }_{y} π ( x , y ) = P ( x ) ,$$

$$and$$

$$∀ x ∈ {Ω}^{k} , y ∈ Ω , π ( x , y ) \geq 0 .$$

It will be appreciated that the linear programming problem expressed above can have |Ω|^{k+1} variables and |Ω|^{k}+|Ω| equality constraints. It will be appreciated that linear programming can be solved in an amount of time that is polynomial with respect to a number of variables and constraints. In some instances, Cost(x, y) can be equal to 1.0 where y is not a member of the set of draft tokens in x, and 0.0 where y is a member of the set of k draft tokens in x. In such instances, when k=1, there is a closed form expression for the optimal acceptance cost, which can be achieved by the maximum coupling between p and q. The closed form expression can be the expression below, where p(x) can be a conditional probability of token x of the lower-latency model 104, and q(x) can be a conditional probability of token x of the higher-latency model 108:

$${min}_{π ∈ Π ( p , q )} {ℙ}_{X , Y ∼ π} ( Y \neq X ) = {\sum }_{x ∈ Ω} min ( p ( x ) , q ( x ) )$$

For larger values of k, there may in some instances be no known general closed form expression for the optimal acceptance cost. However, it will be appreciated that the optimal acceptance cost can be shown to monotonically decrease as k increases and can be shown to tend toward zero (e.g., optimal acceptance probability of 1.0) as k tends toward infinity in instances where all members of a vocabulary of the higher-latency model 108 are associated with a non-zero probability of being generated as draft tokens 206 by the lower-latency model(s) 104. (In instances where some vocabulary members cannot be generated as draft tokens 206, the optimal acceptance probability tends toward 1.0−sum(q(impossibleTokens)), where q is a conditional probability distribution of the higher-latency model 108.) An optimal k-draft acceptance probability αₖ(p, q) based on the above equations can also satisfy the following information-theoretic upper and lower bounds, wherein p is a probability distribution of a lower-latency model 104 and q is a probability distribution of a higher-latency model 108:

$$( 1 - {( 1 - 1 / k )}^{k} ) \cdot {\overline{α}}_{k} ( p , q ) \leq {α}_{k} ( p , q ) \leq {\overline{α}}_{k} ( p , q ) ,$$

$$where$$

$${\overline{α}}_{k} ( p , q ) = {min}_{{Ω}_{0} ⊂ Ω} \{ {\sum }_{y ∈ {Ω}_{0}} min \{ q ( y ) , 1 - {( 1 - p ( y ) )}^{k} \} + {\sum }_{{x}^{k} ∈ {Ω}^{k}} min \{ {\prod }_{i = 1}^{k} p ( {x}_{i} ) , {\sum }_{y ∈ {x}^{k} ∩ {Ω}_{0}^{c}} q ( y ) \} \} .$$

As explained above, a mapping can in some instances comprise an optimal transport plan configured to minimize a cost (e.g., a rejection probability associated with a probability that a corrected token 216 will need to be generated). However, in other instances, a mapping can comprise a less-than-optimal transport plan (e.g., heuristic, etc.). For example, in some instances, a mapping may comprise a near-optimal transport plan having a bounded cost near an optimal value.

In some instances, a near-optimal transport plan can comprise a probabilistic mapping based on a conditional probability distribution of a lower-latency model 104, a conditional probability distribution of a higher-latency model 108, and a division factor (e.g., a real number between 1 and k). In some instances, a near-optimal transport plan can comprise probabilistically determining whether to accept a draft token 206 according to the following equations, wherein ρ is a division factor between 1 and k, q is a probability distribution of a higher-latency model 108, ρ is a probability distribution of a lower-latency mode 104 and Xᵢ is a draft token 206 associated with an ith draft sequence 106.
For i=1, 2, . . . , k Sample ηᵢ˜U(0,1).

If

$${η}_{i} \leq min ( 1 , \frac{q ( {X}_{i} )}{ρ \cdot p ( {X}_{i} )} ) ,$$

then accept Xᵢ as an accepted token 214.

In some instances, a division factor ρ can be greater than or equal to ρ*, wherein ρ* can be a solution to the identity below:

$$1 - {( 1 - {β}_{p , q} ( ρ ) )}^{k} = ρ {β}_{p , q} ( ρ ) ,$$

$$where :$$

$${β}_{p , q} ( ρ ) = {\sum }_{x ∈ Ω} min ( p ( x ) , q ( x ) / ρ )$$

In some instances, value ρ* can be determined efficiently using a search (e.g., binary search) over the range [1, k] because the function f(ρ) below can be continuous, monotonically increasing in the range [1, k], and can have a root in the range [1, k]:

$$f ( ρ ) = 1 - {( 1 - {β}_{p , q} ( ρ ) )}^{k} - ρ {β}_{p , q} ( ρ ) .$$

At a high-level, an above-described near-optimal transport plan can go over all k samples X₁, . . . , Xₖ generated from p sequentially, and can decide on whether to accept each Xᵢ based on the ratio q(Xᵢ)/p(Xᵢ). A near-optimal transport plan can include accepting the first accepted draft token 206 in the output sequence 110 or can include generating a corrected token 216 if none of the draft tokens 206 is accepted in a particular iteration (e.g., if none of the second draft tokens 206b are accepted, then a corrected token 216 can be generated as a sequentially second token in an output sequence 110). Systems and methods for generating a corrected token 216 are further described below.

Generating a corrected token 216 can comprise, for example, sampling a corrected token according to the mapping used to determine accepted and rejected tokens. In some instances, generating a corrected token 216 can comprise random sampling from a residual probability distribution. In some instances, the residual probability distribution can be determined based on a conditional probability of the lower-latency model 104 and the higher-latency model 108. In some instances, the residual distribution can be configured to ensure that a sum of a conditional probability distribution of corrected tokens 216 and a conditional probability distribution of accepted tokens 214 can be equal to a conditional probability distribution of the higher-latency model 108. For example, in some instances k can be one and a mapping can comprise probabilistically accepting a token x with a probability of min(1, q(x)/p(x)), where p(x) can be a conditional probability of the lower-latency model 104 and q(x) can be a conditional probability of the higher-latency model 108. In such instances, a residual distribution can be:

$$∀ x ∈ Ω , {p}^{res} ( x ) = \frac{q ( x ) - min \{ p ( x ) , q ( x ) \}}{1 - {\sum }_{{x}^{′}} min \{ p ( x ' ) , q ( x ' ) \}} .$$

It will be appreciated that in instances where k is greater than one or a mapping comprises a different acceptance strategy, a different probability distribution can be used to cause a sum of a conditional probability distribution of corrected tokens 216 and a conditional probability distribution of accepted tokens 214 to be equal to a conditional probability distribution of the higher-latency model 108. In such instances, a residual distribution causing such a result can be generalized according to the following equation, where accepted (x) can be a probability that a token x is generated as a draft token 206 and accepted as an accepted token 214.

$$∀ x ∈ Ω , {p}^{res} ( x ) = \frac{q ( x ) - accepted ( x )}{1 - {\sum }_{{x}^{′}} accepted ( {x}^{′} )} .$$

For example, in instances where k is greater than one and draft tokens 206 are accepted and rejected according to an above-described near-optimal transport plan, a residual distribution can in some instances correspond to the following equations, where ρ is a tuneable division factor, p(x) is a conditional probability of the lower-latency model 104, and q(x) is a conditional probability of the higher-latency model 108:

$$Let {β}_{p , q} ( ρ ) = {\sum }_{x ∈ Ω} min ( p ( x ) , q ( x ) / ρ )$$

$$and$$

$${p}_{acc} = 1 - {( 1 - {β}_{p , q} ( ρ ) )}^{k} ;$$

$$∀ x ∈ Ω , {p}^{res} ( x ) = \frac{q ( x ) - min \{ p ( x ) , \frac{q ( x )}{ρ} \} \frac{{p}_{acc}}{{β}_{p , q} ( ρ )}}{1 - {p}_{acc}} .$$

It will be appreciated that when ρ is greater than or equal to ρ*, a near-optimal transport plan comprising the above residual distribution can cause a sum of a conditional probability distribution of corrected tokens 216 and a conditional probability distribution of accepted tokens 214 to be equal to a conditional probability distribution of the higher-latency model 108. When ρ is equal to ρ* as described above, a lower bound of the acceptance probability can be shown by the following equation, where αₖ is an upper bound of the optimal acceptance probability associated with the optimal transport plan, and α(π_{ρ*}^{k-Seq}) is an acceptance probability of an above-described near-optimal transport plan comprising the above residual distribution:

$$α ( {π}_{{ρ}^{*}}^{k - Seq} ) \geq ( 1 - {e}^{- 1} ) {α}_{k} ( p , q ) .$$

Thus, it will be appreciated that a near-optimal transport plan can have a bounded acceptance probability that is at least (1−(1−1/k)^{k}) times an upper bound of the optimal acceptance probability. Example comparisons between acceptance probabilities of described optimal and near-optimal transport plans are provided in the Example Results section below.

FIG. 3 is an illustration of an example plurality of draft sequences and an associated example output sequence according to example embodiments of the present disclosure.

In a first depicted step, there are four first draft tokens 206a generated by a lower-latency model 104 based on a context 102. From these four first draft tokens 206a, the computing system 212 accepts the word “the,” which happened to appear as a first draft token 206a in two different draft sequences 106. Where two or more draft sequences 106 include an accepted token 214 as a first draft token 206a of each sequence, then two or more second draft tokens 206b can be considered for inclusion in the output sequence 110 (e.g., a second draft token 206b for each sequence beginning with the accepted token 214). Thus, all tokens following “the” can be valid second draft tokens 206b from the lower-latency model 104 and can be considered for inclusion in an output sequence 110 immediately following the accepted token 214 “the.”

In a second depicted step, there are two second draft tokens 206b remaining under consideration and the computing system 112 accepts the word “aroma,” which appears only once. In a third depicted step, the “of” following the accepted token “aroma” can in some instances be the only third draft token 208c under consideration. In the depicted third step, the computing system 112 accepts the third token 208c and then samples an additional token 320 from a conditional probability distribution of the higher-latency model 108.

FIG. 3 depicts one or more rejected token(s) 318. Rejected tokens 318 can comprise, for example, various types of data configured to form part of a sequence (e.g., text data, image data, audio data, semantic data, etc.). In some instances, a rejected token 318 can be, comprise, be the same as, or share one or more properties with a draft token 206. Rejected tokens 318 can in some instances be draft tokens not selected for inclusion in an output sequence 110.

FIG. 3 depicts an additional token 320. An additional token 320 can comprise, for example, various types of data configured to form part of a sequence (e.g., text data, image data, audio data, semantic data, etc.). In some instances, the additional token 320 can be sampled from a conditional probability distribution of the higher latency model 108. In some instances, the conditional probability distribution of the higher-latency model 108 can be based on the context 102 and all draft tokens 206 of a draft sequence 106. For example, in some instances, a plurality of k conditional next-token probability distributions of the higher-latency model can be computed based on each draft sequence 106, wherein the next-token probability distributions are conditional on the context 102 and all n draft tokens 206 of each draft sequence 106. In such instances, an additional token 320 can be sampled from a next-token probability distribution of the higher-latency model 108 whenever all n draft tokens 206 of a draft sequence 106 are accepted as accepted tokens 214. In some instances, the k conditional next-token probability distributions can be determined in parallel with other conditional probability distributions of the higher-latency model 108 (e.g., conditional probability distributions used in determining whether to accept or reject one or more draft tokens 206, as described above).

In some instances, the systems described in FIGS. 1 through 3 can perform one or more steps as described in the pseudocode below:

Subroutine DraftSelection(Input: Input sequence x^{t}; draft sequence length: L; draft sequences
S = {zᵢ^{L}|i ≤ |S|})

| | |
|---|---|
| 1: | Compute a transport plan (e.g., using linear programming described above for an optimal |

solution or near-optimal transport plan described above for a suboptimal solution) from a
conditional probability distribution Mₛ(· |x^{t})^{⊗|S|} of the lower-latency model 104 to a conditional
probability distribution M_{b}(·|x^{t}) of the higher-latency model 108, denoted by πₜ.

| | |
|---|---|
| 2: | Get the multi-set of next token-level drafts (e.g., 206a, b, or c): S_{z} = {zᵢ(1)}_{i∈[\|S\|]} and |

compute Y = f_{π}_{ₜ}(S_{z}), wherein Y is an accepted token 214 or corrected token 216 based on the
transport plan.

| | |
|---|---|
| 3: | if L = 1 then (If this is a last draft token 206 of a draft sequence 106) |
| 4: | if Y ∈ S_{z} then (If the token Y is an accepted token 214, sample an additional token 320.) |
| 5: | Sample Y′~M_{b} (· \|(x^{t}, Y)). |
| 6: | Return (x^{t}, Y, Y′). |
| 7: | else |
| 8: | Return (x^{t}, Y). (If the token Y is a corrected token 216, stop and return the |

corrected token and previous accepted tokens. )

| | |
|---|---|
| 9: | end if |
| 10: | else |
| 11: | Let Sₙₑₓₜ = {z^{2:L}\|z ∈ S and z(1) = Y} be the set that consists of sub-sequences of the |
| | candidates that agree with the selected next token. |
| 12: | if Sₙₑₓₜ = Ø then |
| 13: | Return (x^{t}, Y). (Stop and return the corrected token 216 and any previous |

accepted tokens.)

| | |
|---|---|
| 14: | else |
| 15: | Return DraftSelection ((x^{t}, Y), L − 1, Sₙₑₓₜ). (Add the accepted token 214 to |

the output sequence 110 and proceed to the next sequential step.)

| | |
|---|---|
| 16: | end if |
| 17: | end if |

### Example Results

In some example experiments according to the present disclosure, systems and methods of the present disclosure were compared to prior systems and methods for generating an output sequence associated with a higher-latency model 108. For example, systems and methods using eight-sequence pluralities of parallel draft sequences 106 were compared to systems and methods using one draft sequence 106 at a time and baseline systems and methods that did not use draft sequences 106 at all. Sequence lengths of four tokens and eight tokens were tested, and results were averaged over 1000 test prompts and three different random seeds. The same higher-latency model 108 was used in all test conditions, and the same lower-latency model 104 was used for all test conditions involving draft sequences 106. In the experiments, multi-sequence systems and methods of the present disclosure showed a wallclock speedup of 2.08-2.13 times faster than the baseline, compared to a 1.56-1.67× speedup for single-sequence speculative decoding methods.

In some example analyses according to the present disclosure, near-optimal transport plans according to the present disclosure were compared to optimal transport plans according to the present disclosure. For example, transport plans were generated between pairs of uniform distributions and pairs of Bernoulli distributions. For transport plans between pairs of uniform distributions, acceptance probabilities of near-optimal transport plans of the present disclosure were equal to the optimal acceptance probabilities. For transport plans between pairs of Bernoulli distributions, acceptance probabilities of near-optimal transport plans of the present disclosure were in some instances worse than the optimal acceptance probabilities and in some instances the same as optimal acceptance probabilities.

### Example Methods

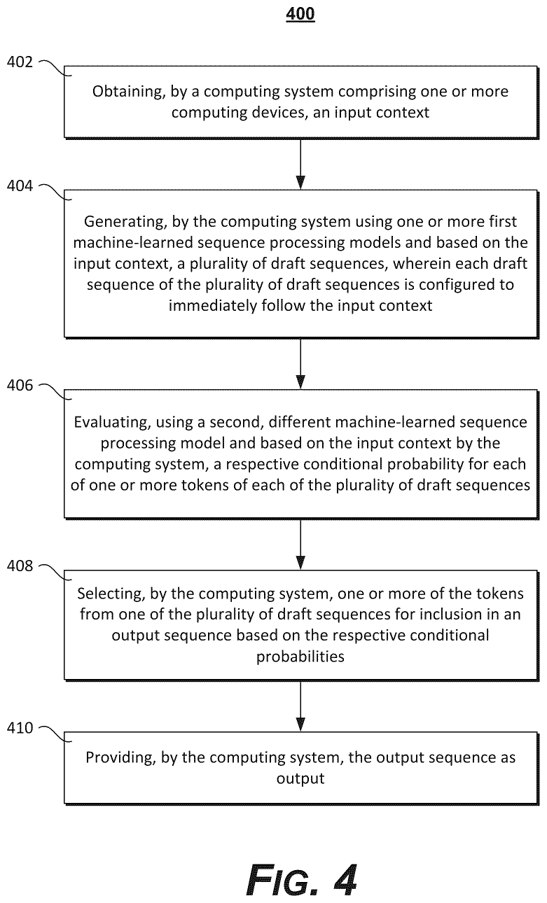

FIG. 4 depicts a flowchart diagram of an example method for generating an output sequence based on an input context according to example embodiments of the present disclosure. Although FIG. 4 depicts steps performed in a particular order for purposes of illustration and discussion, the methods of the present disclosure are not limited to the particularly illustrated order or arrangement. The various steps of example method 400 can be omitted, rearranged, combined, and/or adapted in various ways without deviating from the scope of the present disclosure.

At 402, example method 400 can include obtaining, by a computing system comprising one or more computing devices, an input context. In some instances, an input context can be, comprise, or be comprised by a context 102. In some instances, step 402 can include one or more steps described with respect to FIGS. 1-3.

At 404, example method 400 can include generating, by the computing system using one or more first machine-learned sequence processing models and based on the input context, a plurality of draft sequences, wherein each draft sequence of the plurality of draft sequences is configured to immediately follow the input context. In some instances, a first machine-learned sequence processing model can be, comprise, or be comprised by a lower-latency model 104. In some instances, a draft sequence can be, comprise, or be comprised by a draft sequence 106. In some instances, step 404 can include one or more steps described with respect to FIGS. 1-3.

At 406, example method 400 can include evaluating, using a second, different machine-learned sequence processing model and based on the input context by the computing system, a respective conditional probability for each of one or more tokens of each of the plurality of draft sequences. In some instances, the second, different machine-learned model can be, comprise, or be comprised by a higher-latency model 108. In some instances, a respective conditional probability can be, comprise, or be comprised by a token probability 210. In some instances, step 406 can include one or more steps described with respect to FIGS. 1-3.

At 408, example method 400 can include selecting, by the computing system, one or more of the tokens from one of the plurality of draft sequences for inclusion in an output sequence based on the respective conditional probabilities. In some instances, an output sequence can be, comprise, or be comprised by an output sequence 110. In some instances, step 408 can include one or more steps described with respect to FIGS. 1-3.

At 410, example method 400 can include providing, by the computing system, the output sequence as output. In some instances, an output sequence can be, comprise, or be comprised by an output sequence 110. In some instances, step 408 can include one or more steps described with respect to FIGS. 1-3.

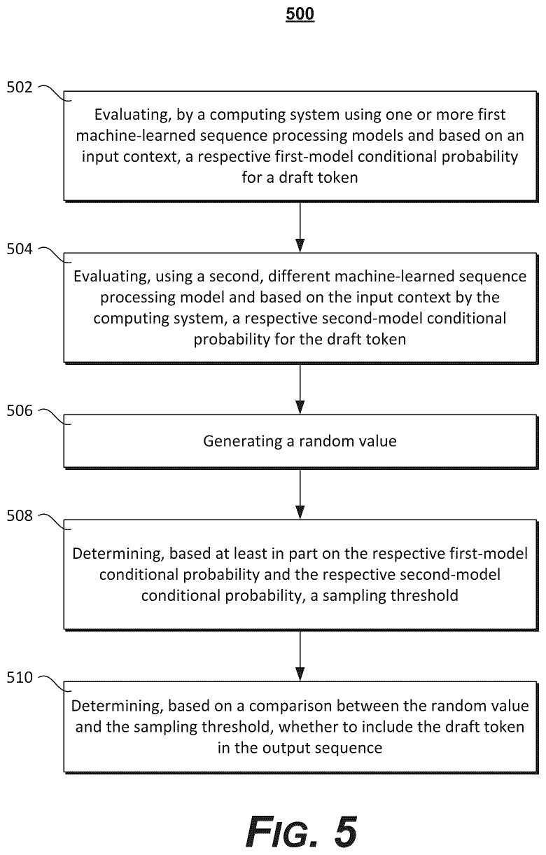

FIG. 5 depicts a flowchart diagram of an example method for determining whether to include or not include a draft token in an output sequence according to example embodiments of the present disclosure. Although FIG. 5 depicts steps performed in a particular order for purposes of illustration and discussion, the methods of the present disclosure are not limited to the particularly illustrated order or arrangement. The various steps of example method 500 can be omitted, rearranged, combined, and/or adapted in various ways without deviating from the scope of the present disclosure.

At 502, example method 500 can include evaluating, by a computing system using one or more first machine-learned sequence processing models and based on an input context, a respective first-model conditional probability for a draft token. In some instances, a first model can be, comprise, or be comprised by a lower-latency model 104. In some instances, a draft token can be, comprise, or be comprised by a draft token 206. In some instances, step 502 can include one or more steps described with respect to FIGS. 1-3.

At 504, example method 500 can include evaluating, using a second, different machine-learned sequence processing model and based on the input context by the computing system, a respective second-model conditional probability for the draft token. In some instances, a second model can be, comprise, or be comprised by a higher-latency model 108. In some instances, a second-model conditional probability can be, comprise, or be comprised by a token probability 210. In some instances, step 504 can include one or more steps described with respect to FIGS. 1-3.

At 506, example method 500 can include generating a random value. In some instances, step 506 can include one or more steps described with respect to FIGS. 1-3.

At 508, example method 500 can include determining, based at least in part on the respective first-model conditional probability and the respective second-model conditional probability, a sampling threshold. In some instances, step 508 can include one or more steps described with respect to FIGS. 1-3.

At 510, example method 500 can include determining, based on a comparison between the random value and the sampling threshold, whether to include the draft token in the output sequence. In some instances, an output sequence can be, comprise, or be comprised by an output sequence 110. In some instances, step 510 can include one or more steps described with respect to FIGS. 1-3.

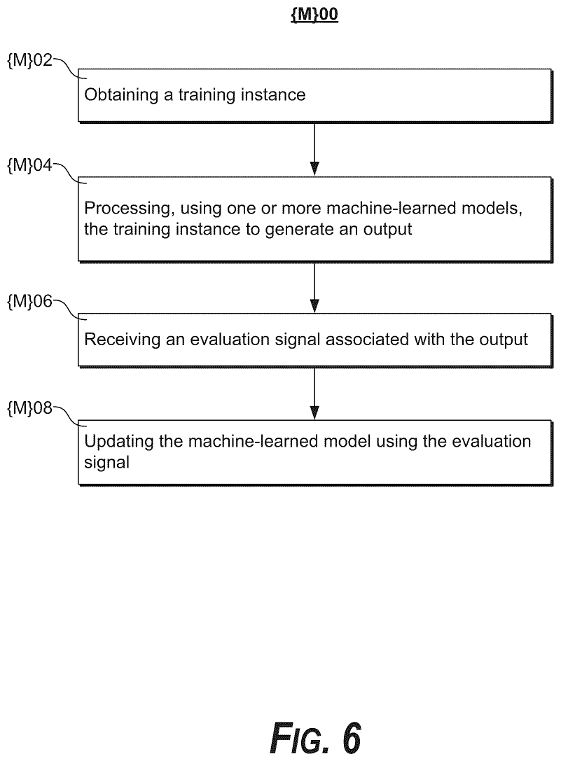

FIG. 6 depicts a flowchart of a method 600 for training one or more machine-learned models according to aspects of the present disclosure. For instance, an example machine-learned model can include a lower-latency model 104 or higher-latency model 108.

One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types. In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

### Example Machine-Learned Models

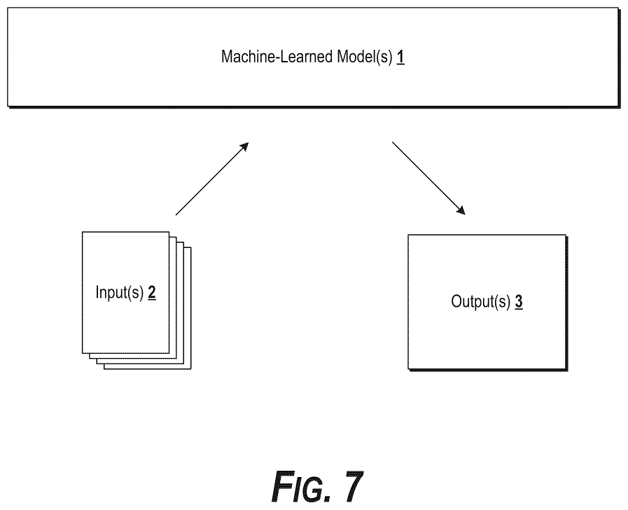

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

### Example Machine-Learned Sequence Processing Models

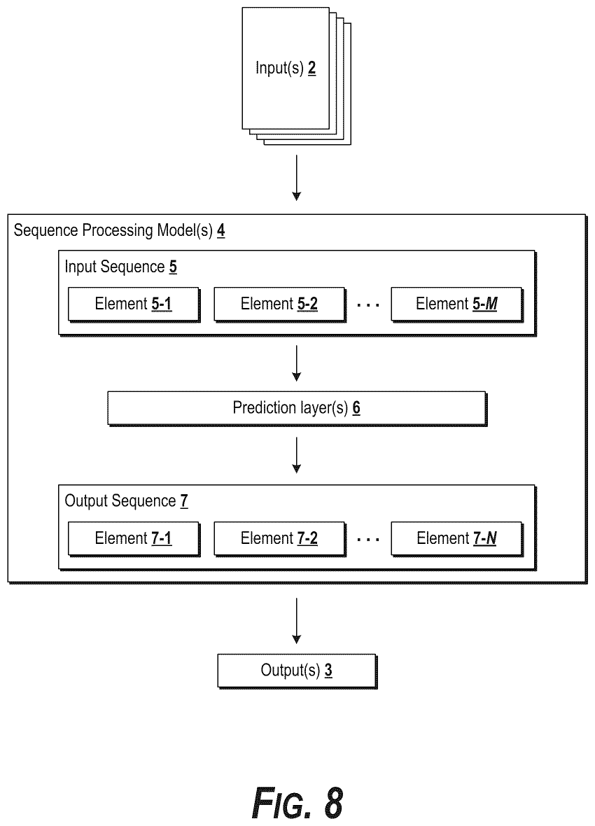

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV: 2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (Oct. 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 8 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

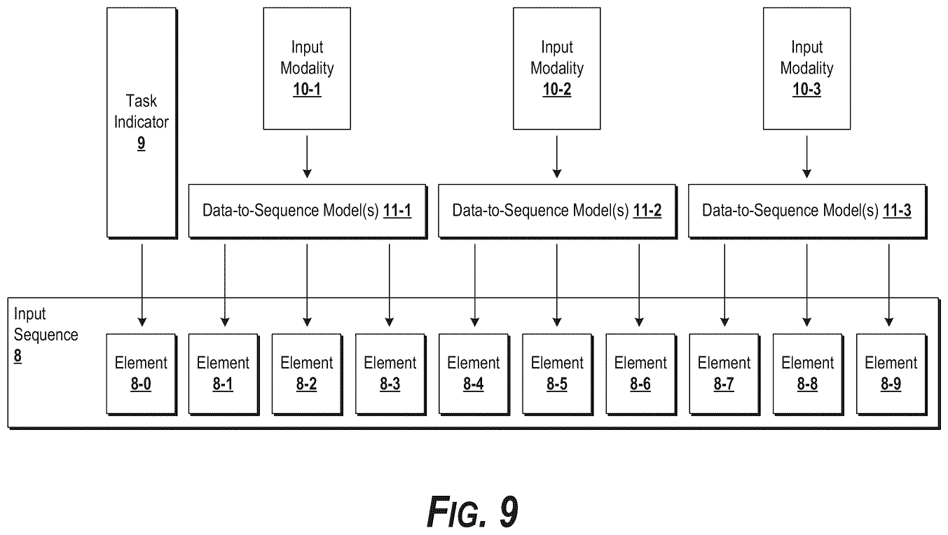

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be a learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

### Example Machine-Learned Model Development Platform

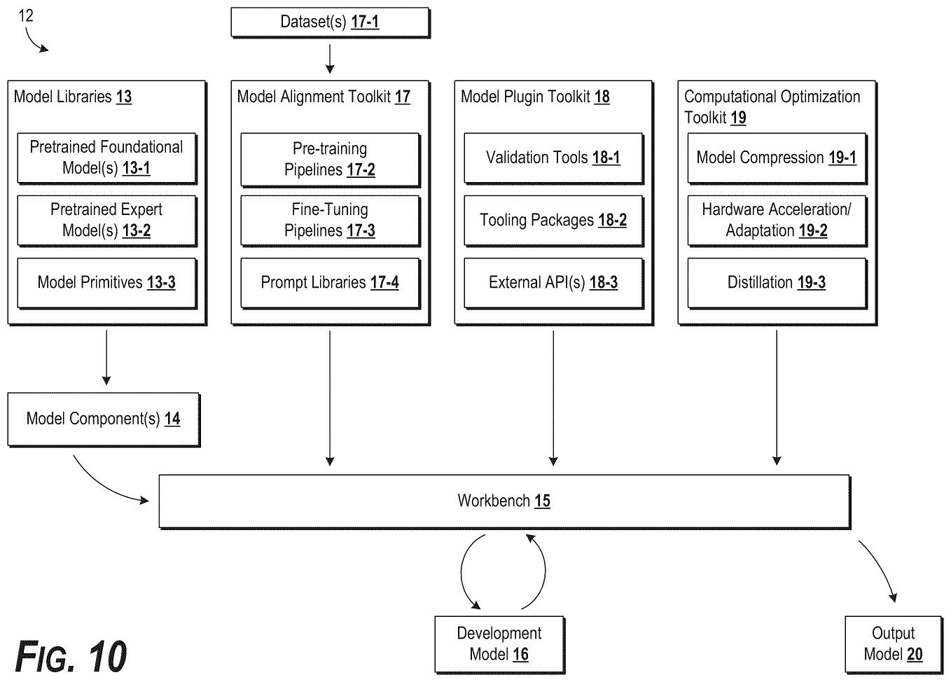

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing an accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output a input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instruction that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

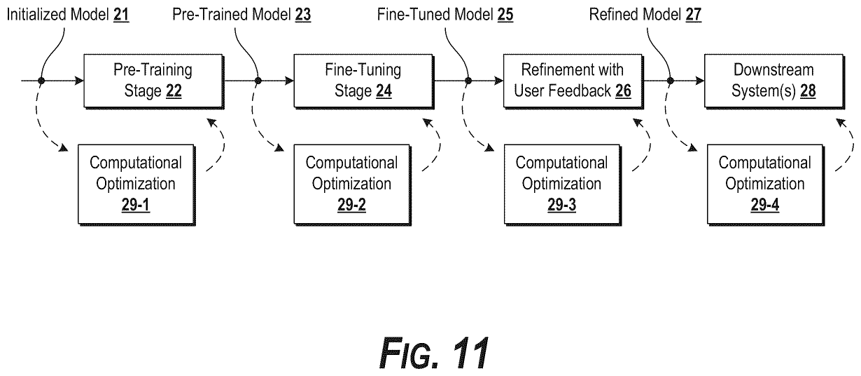

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model as satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

### Example Machine-Learned Model Inference System

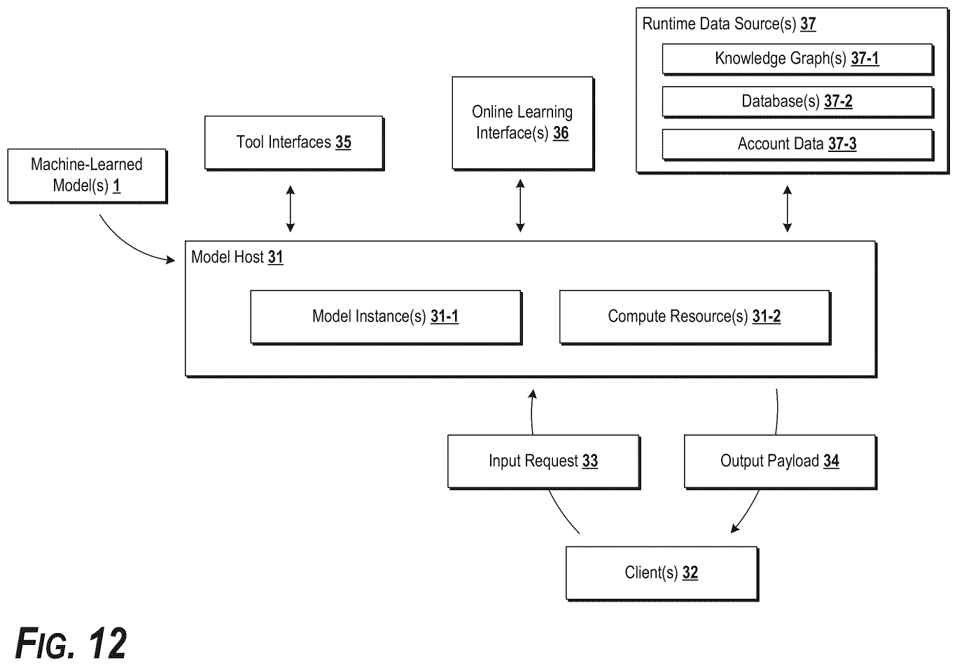

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on a same device or system as client(s) 32. Model host 31 can be a machine-learning service that runs on-device to provide machine-learning functionality to one or multiple applications operating on a client device, which can include an application implementing client(s) 32. Model host 31 can be a part of a same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored on in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

### Example Computing Systems and Devices

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

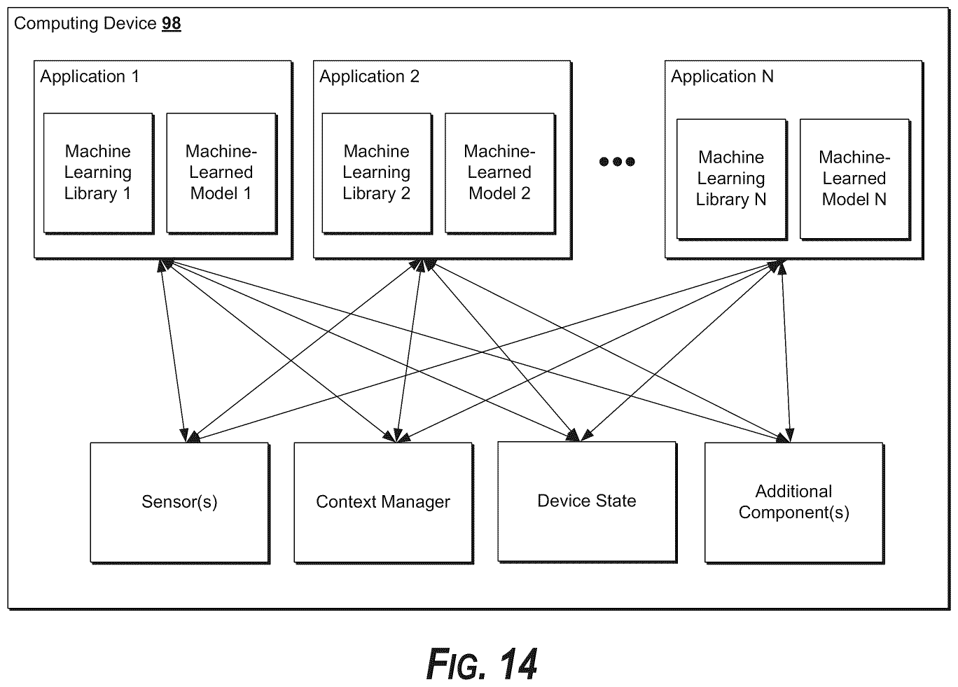

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

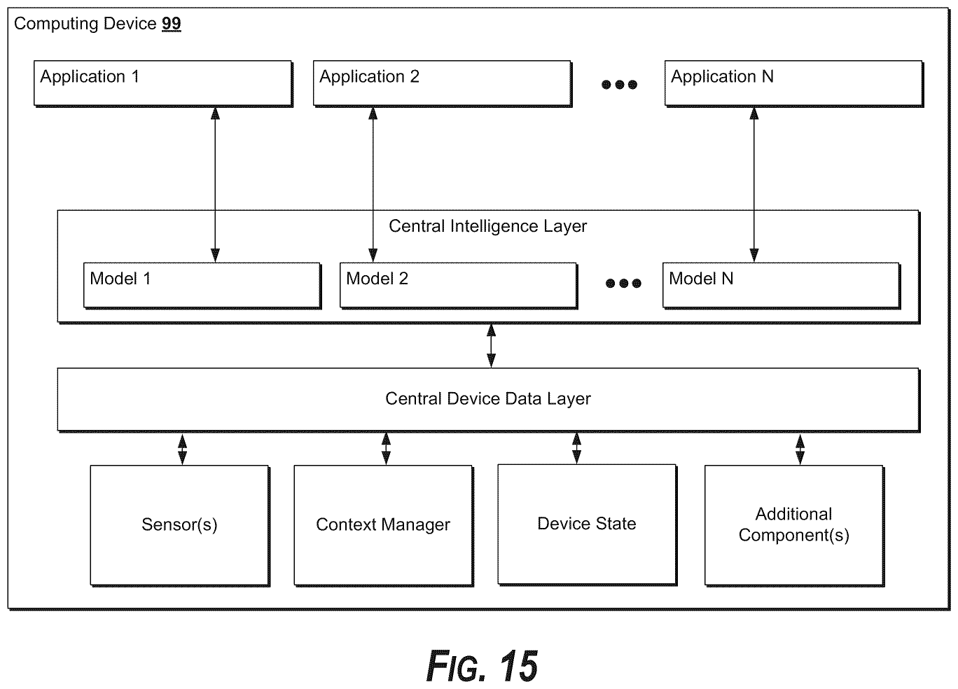

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
obtaining, by a computing system comprising one or more computing devices, an input context;
generating, by the computing system using one or more first machine-learned sequence processing models and based on the input context, a plurality of draft sequences, wherein each draft sequence of the plurality of draft sequences is configured to immediately follow the input context;
evaluating, using a second, different machine-learned sequence processing model and based on the input context by the computing system, a respective conditional probability for each of one or more tokens of each of the plurality of draft sequences;
selecting, by the computing system, one or more of the tokens from one of the plurality of draft sequences for inclusion in an output sequence based on the respective conditional probabilities; and
providing, by the computing system, the output sequence as output.

2. The method of claim 1, wherein:
a first draft sequence of the plurality of draft sequences comprises a first draft token associated with a first respective conditional probability;
a second draft sequence of the plurality of draft sequences comprises a second draft token associated with a second respective conditional probability; and
evaluating comprises evaluating the first respective conditional probability and second respective conditional probability in parallel.

3. The method of claim 1, wherein:
the respective conditional probability is a respective second-model conditional probability;
generating a draft sequence comprises evaluating, using the one or more first machine-learned sequence processing models and based on the input context by the computing system, a respective first-model conditional probability for each of the one or more tokens of each of the plurality of draft sequences; and
selecting one or more tokens for inclusion in an output sequence comprises determining, based on a comparison between at least one respective first-model conditional probability and at least one respective second-model conditional probability, whether to include a draft token associated with the at least one respective first-model conditional probability and the at least one respective second-model conditional probability.

4. The method of claim 3, wherein determining whether to include the draft token comprises:
generating a random value;
determining, based at least in part on the respective first-model conditional probability and the respective second-model conditional probability, a sampling threshold; and
determining, based on a comparison between the random value and the sampling threshold, whether to include the draft token in the output sequence.

5. The method of claim 4, wherein a ratio ρ of a quotient q(x)/p(x) to the sampling threshold is between 1 and k inclusive, wherein q(x) is the respective second-model conditional probability, p(x) is the respective first-model conditional probability, and k is a number of draft sequences of the plurality of draft sequences.

6. The method of claim 5, wherein the ratio ρ of the quotient to the sampling threshold is greater than or equal to ρ*, where
$${ρ}^{*} = \frac{1 - {( 1 - {\sum }_{x ∈ Ω} min ( p ( x ) , \frac{q ( x )}{{ρ}^{*}} ) )}^{k}}{{\sum }_{x ∈ Ω} min ( p ( x ) , \frac{q ( x )}{{ρ}^{*}} )} .$$

7. The method of claim 1, wherein a probability distribution of the output sequence is equivalent to a probability distribution of the second machine-learned sequence processing model.

8. The method of claim 1, wherein selecting one or more tokens for inclusion comprises:
obtaining a valid transport plan between a probability distribution of the one or more first machine-learned sequence processing models and a probability distribution of the second machine-learned sequence processing model; and
determining, based on the valid transport plan, whether to accept a draft token of the plurality of draft sequences.

9. The method of claim 8, wherein obtaining the valid transport plan comprises linear programming.

10. The method of claim 3, wherein the draft token associated with the at least one respective first-model conditional probability and the at least one respective second-model conditional probability is not included in the output sequence, and further comprising:
determining, by the computing system and using a conditional probability distribution of the one or more first machine-learned sequence processing models and a conditional probability distribution of the second machine-learned sequence processing model, a residual probability distribution; and
determining, based on the residual probability distribution, an output token to include in the output sequence.

11. The method of claim 10, wherein determining the output token comprises random sampling based on the residual probability distribution.

12. The method of claim 3, wherein the draft token associated with the at least one respective first-model conditional probability and the at least one respective second-model conditional probability is included in the output sequence, and further comprising:
determining, using the second machine-learned sequence processing model and based at least in part on the input context and the draft token associated with the at least one respective first-model conditional probability and the at least one respective second-model conditional probability, a conditional probability distribution of the second machine-learned sequence processing model;
randomly sampling an additional output token based on the conditional probability distribution; and
including the additional output token in the output sequence.

13. A computing system comprising:
one or more processors; and
one or more non-transitory computer-readable media storing instructions that are executable by the one or more processors to cause the computing system to perform one or more operations, the operations comprising:
obtaining an input context;
generating, using one or more first machine-learned sequence processing models and based on the input context, a plurality of draft sequences, wherein each draft sequence of the plurality of draft sequences is configured to immediately follow the input context;
evaluating, using a second, different machine-learned sequence processing model and based on the input context, a respective conditional probability for each of one or more tokens of each of the plurality of draft sequences;
selecting one or more of the tokens from one of the plurality of draft sequences for inclusion in an output sequence based on the respective conditional probabilities; and
providing the output sequence as output.

14. The computing system of claim 13, wherein:
a first draft sequence of the plurality of draft sequences comprises a first draft token associated with a first respective conditional probability;
a second draft sequence of the plurality of draft sequences comprises a second draft token associated with a second respective conditional probability; and
evaluating comprises evaluating the first respective conditional probability and second respective conditional probability in parallel.

15. The computing system of claim 13, wherein:
the respective conditional probability is a respective second-model conditional probability;
generating a draft sequence comprises evaluating, using the one or more first machine-learned sequence processing models and based on the input context, a respective first-model conditional probability for each of one or more tokens of each of the plurality of draft sequences; and
selecting one or more tokens for inclusion in an output sequence comprises determining, based on a comparison between at least one respective first-model conditional probability and at least one respective second-model conditional probability, whether to include a draft token associated with the at least one respective first-model conditional probability and the at least one respective second-model conditional probability.

16. The computing system of claim 15, wherein determining whether to include the draft token comprises:
generating a random value;
determining, based at least in part on the respective first-model conditional probability and the respective second-model conditional probability, a sampling threshold; and
determining, based on a comparison between the random value and the sampling threshold, whether to include the draft token in the output sequence.

17. The computing system of claim 13, wherein a probability distribution of the output sequence is equivalent to a probability distribution of the second machine-learned sequence processing model.

18. The computing system of claim 15, wherein the draft token associated with the at least one respective first-model conditional probability and the at least one respective second-model conditional probability is not included in the output sequence, and further comprising:
determining, using a conditional probability distribution of the one or more first machine-learned sequence processing models and a conditional probability distribution of the second machine-learned sequence processing model, a residual probability distribution; and
determining, based on the residual probability distribution, an output token to include in the output sequence.

19. The computing system of claim 15, wherein the draft token associated with the at least one respective first-model conditional probability and the at least one respective second-model conditional probability is included in the output sequence, and further comprising:
determining, using the second machine-learned sequence processing model and based at least in part on the input context and the draft token associated with the at least one respective first-model conditional probability and the at least one respective second-model conditional probability, a conditional probability distribution of the second machine-learned sequence processing model;
randomly sampling an additional output token based on the conditional probability distribution; and
including the additional output token in the output sequence.

20. One or more non-transitory computer-readable media storing instructions that are executable by a computing system to perform one or more operations, the operations comprising:
obtaining an input context;
generating, using one or more first machine-learned sequence processing models and based on the input context, a plurality of draft sequences, wherein each draft sequence of the plurality of draft sequences is configured to immediately follow the input context;
evaluating, using a second, different machine-learned sequence processing model and based on the input context, a respective conditional probability for each of one or more tokens of each of the plurality of draft sequences;
selecting one or more of the tokens from one of the plurality of draft sequences for inclusion in an output sequence based on the respective conditional probabilities; and
providing the output sequence as output.
